(19) United States
(12) Patent Application Publication
(10) Pub. No.: US 2025/0052881 A1
(43) Pub. Date: Feb. 13, 2025

(54) VEHICULAR CABIN MONITORING SYSTEM USING RADAR SYSTEM

(71) Applicant: Magna Electronics Inc., Auburn Hills, MI (US)

(72) Inventors: Ha Bui-Van, Aschaffenburg (DE); Wilhelm Johann Wolfgang Wöhlte, Sailauf (DE)

(21) Appl. No.: 18/796,703

(22) Filed: Aug. 7, 2024

Related U.S. Application Data
(60) Provisional application No. 63/518,142, filed on Aug. 8, 2023.

(51) Int. Cl. G01S 13/04; G01S 7/41; G01S 13/86; G01S 13/931

(52) U.S. Cl. CPC G01S 13/04; G01S 7/41; G01S 13/86; G01S 13/931; G01S 2013/9322; G01S 2013/93276; G01S 2013/9329

(57) ABSTRACT

A vehicular radar sensing system includes a radar sensor and a reflector disposed at an interior cabin of a vehicle. The reflector includes a plurality of radar-reflective portions. Transmitted radio signals from the radar sensor reflect off the radar-reflective portions of the reflector toward respective regions of interest of a plurality of regions of interest within the vehicle. Each radar-reflective portion of the plurality of radar-reflective portions of the reflector reflects transmitted radio signals toward a different respective region of interest of the plurality of regions of interest. Received radio signals include radio signals that reflect off the reflector toward the radar sensor. The vehicular radar sensing system, responsive to processing of captured radar data, determines presence of an occupant of the vehicle at one of the regions of interest of the plurality of regions of interest.

### CROSS REFERENCE TO RELATED APPLICATION

The present application claims the filing benefits of U.S. provisional application Ser. No. 63/518, 142, filed Aug. 8, 2023, which is hereby incorporated herein by reference in its entirety.

### FIELD OF THE INVENTION

The present invention relates generally to a vehicle sensing system for a vehicle and, more particularly, to a vehicle sensing system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular radar sensing system includes a radar sensor disposed at an interior cabin of a vehicle. The radar sensor senses within the interior cabin of the vehicle. The radar sensor transmits radio signals and receives radio signals. Radar data is captured based on the received radio signals. The system includes an electronic control unit (ECU) that includes electronic circuitry and associated software. Captured radar data is provided to the ECU. The electronic circuitry of the ECU includes at least one data processor. The ECU is operable to process captured radar data provided to the ECU. The system includes a reflector disposed at the interior cabin of the vehicle. The reflector includes a plurality of radar-reflective portions. Each radar-reflective portion of the plurality of radar-reflective portions of the reflector reflects radio signals transmitted by the radar sensor toward a respective region of interest of a plurality of regions of interest within the interior cabin of the vehicle. The received radio signals include radio signals that reflect off the plurality of radar-reflective portions of the reflector toward the radar sensor. The vehicular radar sensing system, via processing at the ECU of captured radar data, determines presence of an occupant of the vehicle at a region of interest of the plurality of regions of interest within the interior cabin of the vehicle.

These and other objects, advantages, purposes and features of the present invention will become apparent upon review of the following specification in conjunction with the drawings.

### BRIEF DESCRIPTION OF THE DRAWINGS

FIG. 1 is a top view of a vehicle with a sensing system that incorporates a radar sensor;

FIG. 2 is a schematic view of a sensing system with a radar sensor disposed at a roof of a vehicle;

FIG. 3 is a schematic view of a sensing system with a radar sensor disposed at a front of a vehicle and a reflector disposed at a roof of the vehicle;

FIG. 4 is a schematic view of the reflector of FIG. 3; and

FIG. 5 is a plot of phase versus size for elements of the reflector of FIG. 4.

### DESCRIPTION OF THE PREFERRED EMBODIMENTS

A vehicle sensing system and/or occupant monitoring system operates to capture sensing data interior of the vehicle and may process the captured data to detect objects within the vehicle, such as to monitor a status of one or more occupants of the vehicle. The system includes a processor that is operable to receive sensing data from one or more sensors and provide an output, such as an alert or control of a vehicle system.

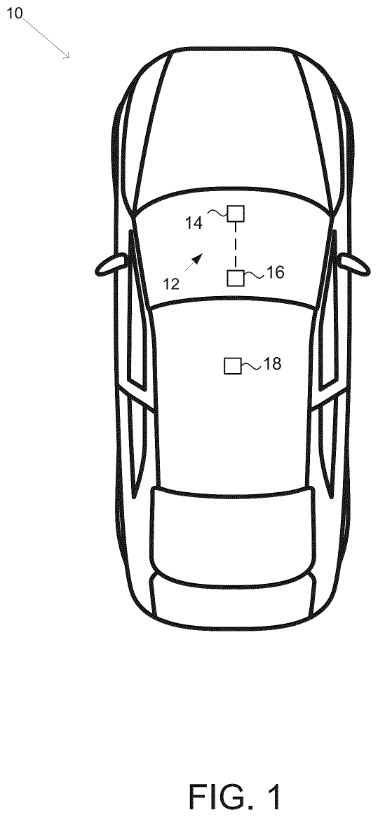

Referring now to the drawings and the illustrative embodiments depicted therein, a vehicle 10 (FIG. 1) includes an occupant monitoring system or sensing system 12 that includes at least one radar sensor unit, such as an interior radar sensor unit 14 (and the system may optionally include multiple sensors, such as cameras, radar, or other sensors), which senses regions interior of the vehicle. The radar sensor 14 may be disposed at any location within the cabin of the vehicle, such as at a dash/dashboard or console of the vehicle. The sensing system 12 includes a control or electronic control unit (ECU) 16 that includes a data processor that is operable to process data captured by the radar sensor(s). The system 12 may include one or more reflectors 18 (e.g., an array of reflectors 18) for reflecting signals transmitted by the radar sensor 14 in one or more directions within the cabin of the vehicle. The radar sensor may include a plurality of transmitters that transmit radio signals via plurality of antennas. The radar sensor may also include a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driver monitoring system or an occupant monitoring system of the vehicle, with the system detecting and/or monitoring at least one occupant of the vehicle (such as to monitor a health or status of the occupant) responsive to processing of the data captured by the radar sensors. The data transfer or signal communication from the sensor to the ECU may comprise any suitable data or communication link, such as a vehicle network bus or the like of the equipped vehicle.

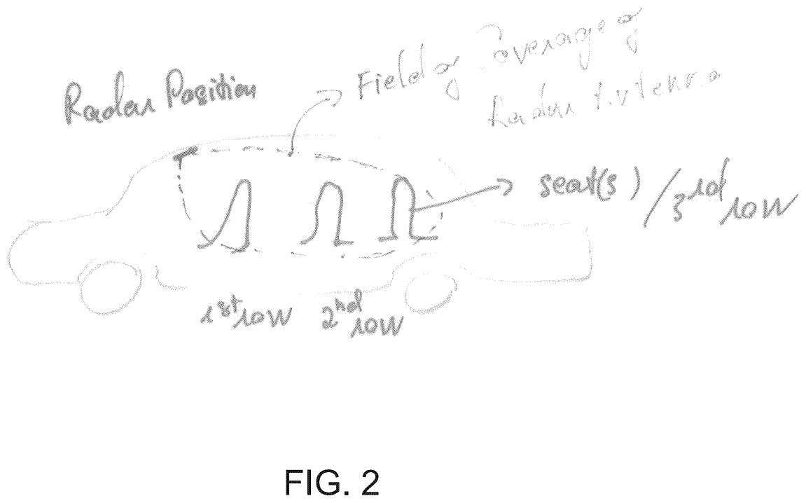

As shown in FIG. 1, the occupant monitoring system 12 includes a radar sensor 14 disposed within the interior of the car. The radar sensor 14 may be installed, for example, at the roof of the vehicle or at a side of the vehicle, which then directly senses the entire cabin or compartment of the vehicle to detect vital signs (e.g., heart rate, breathing rate, etc.) or other status from occupants of the vehicle. However, in this case, the signals emitted by the radar sensor 14 may be reflected by a large number of objects in the field of view of the radar sensor (i.e., the entire interior of the vehicle), which reduces radar performance due to noise. Additionally, the structure of a typical vehicle's interior (e.g., seats) may prevent direct sensing from the radar, when installed at a single position, to all passengers or occupants of the vehicle (e.g., a third row of the vehicle). That is, as illustrated in FIG. 2, it is difficult, if not impossible, to determine a location within the vehicle that allows a radar sensor to have a direct line of sight to all potential passenger locations in the vehicle, including passengers seated at a rear seat or second row of seats of the vehicle. For example, for a large vehicle with a third row of seats, the last/third row of seats is generally difficult or impossible to include in the direct field of sensing of the radar sensor, as the seats of the first and second rows block the field of sensing. Moreover, due to the limited number of antenna elements in radar sensors and/or the wide field of sensing required, the resolution is necessarily limited.

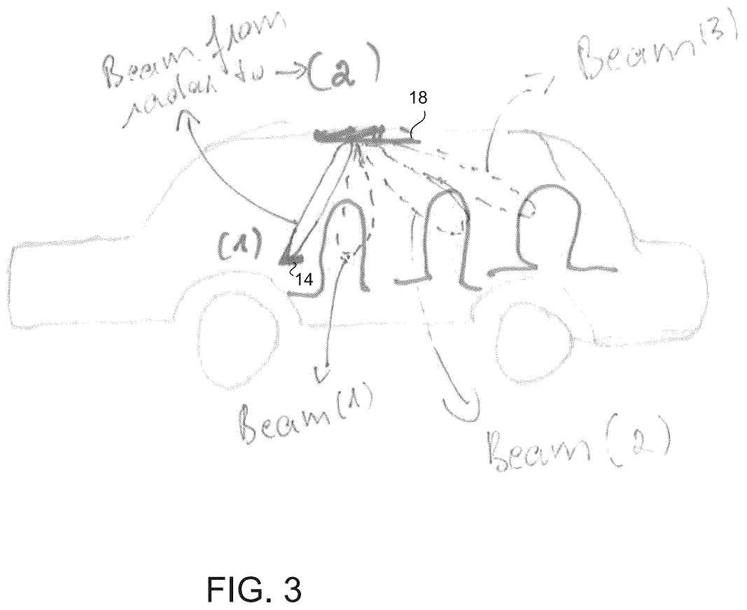

Referring now to FIG. 3, in some examples, the radar sensor 14 is disposed at or near a dash or dashboard or console of the vehicle (or, for example, any other location with a direct line of sight to one or more portions, such as a central portion, of the roof or headliner or pillars of the vehicle). The radar sensor may include a high-gain antenna. One or more radar-reflectors 18 or reflect arrays may be disposed at various locations at the vehicle such as at a roof or headliner of the vehicle or at one or more side pillars of the vehicle (e.g., the A-pillar or the B-pillar of the vehicle). The radar sensor 14 may narrowly direct or transmit signals at the reflectors 18, which in turn bounce or reflect the transmitted radar signals to various specific locations within the cabin of the vehicle. For example, the reflectors direct (via reflections) the radar signals toward one or more seats within the vehicle. When the transmitted signals reach an object (e.g., an occupant, a pet, a seat, etc.), the signals are reflected back to the reflector 18, which reflects the signals back to the radar sensor 14. In this way, the system 12 provides low cluster reflection from different regions of the vehicle, thus improving performance. Moreover, the resolution of the radar sensor 14 is increased by focusing on regions of interest (e.g., locations where occupants may be sitting) instead of most or all of the interior of the vehicle. That is, the field of sensing of the radar sensor is limited only to select regions of interest (e.g., a portion of each seat of the vehicle). Additionally, the radar sensor is easy to install with limited or no blockage introduced by the vehicle's interior.

The radar sensor may direct a separate “beam” to each region of interest (e.g., each seat within the vehicle) using, for example, different transmitters and/or different reflectors 18 or portions/regions of the same reflector 18. For example, FIG. 3 illustrates the system 12 with three beams. Here, a first beam senses regions associated with the first row of seats, a second beam senses regions associated with the second row of seats, and a third beam senses regions associated with the third row of seats. In this example, all three beams are reflected off of the reflector(s) 18. In other examples, the radar sensor may direct one or more beams to a region of interest and one or more beams to the reflectors 18. For example, the radar sensor may directly sense (using a narrow beam) the front row seats and sense the remaining rows of seats via the reflectors 18. Different portions or regions of the reflector 18 may reflect or direct the signals or beams in different directions (e.g., towards the first row of seats, the second row of seats, or the third row of seats).

The radar sensor 14 may include a main or primary printed circuit board (PCB) that includes, for example, a system on a chip (SoC) capable of generating radio frequency (RF) signals and processing received RF signals (i.e., transmitted RF signals reflected off objects). The radar sensor 14 may include a variety of different antennas. For example, the radar sensor 14 includes a focus antenna, such as a horn antenna or an array of antennas with a beamforming system to limit the transmitted RF signals to the direction of the reflector(s) (e.g., different regions of the same reflector or multiple different reflectors) or other regions of interest (e.g., one or more specific seats or rows of seats). The different beams emitted by the radar sensor 14 may be emitted simultaneously (e.g., by multiple different transmitters at the same time) or in sequence by the same or different transmitters. For example, the system 12 performs time-domain multiplexing (TDM) to scan different positions within the vehicle sequentially.

The radar sensor 14 may be installed, for example, at the dashboard of the vehicle or at a center console or armrest of the vehicle without blocking the field of view of the driver of the vehicle. The reflectors 18 may generally be located or installed at higher locations relative to the radar sensor 14. For example, one or more reflectors 18 are installed at a roof or headliner of the vehicle or at an upper portion of a pillar of the vehicle (e.g., the A-pillar or the B-pillar). The reflector(s) 18 are designed to direct the incident signals from the radar sensor 14 at different targeted locations of the vehicle. The reflector 18 may be realized/fabricated using PCB, spinning, hydroforming, and other technologies. The reflectors 18 may make use of any number of technologies to direct radio waves to the desired locations. The reflectors 18 may be metallic reflectors (e.g., aluminum or copper) shaped into precise geometries for optimal reflection. The reflectors 18 may be dielectric reflectors that use composite materials or plastics. The reflectors may be fabricated using mechanical shaping (e.g., cutting, bending, and/or machining), injection molding, 3D printing, and/or electroforming techniques. The reflectors 18 may be polished or include one or more coatings to enhance their reflective properties. The reflectors 18 may include parabolic reflectors, flat reflectors, and/or corner reflectors. The shape and size of the reflectors 18, along with the techniques used to manufacture them may be based on the geometries of the specific vehicle, the required precision of the reflectors, the production volume, cost considerations, etc.

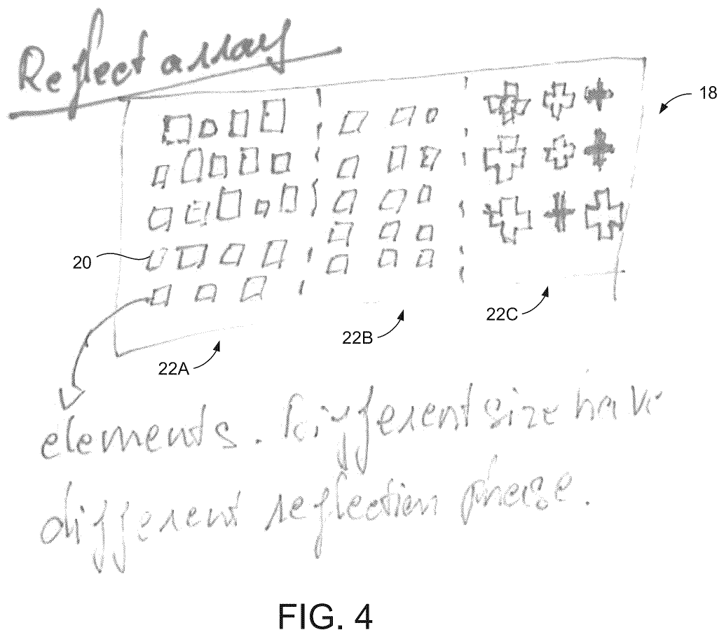

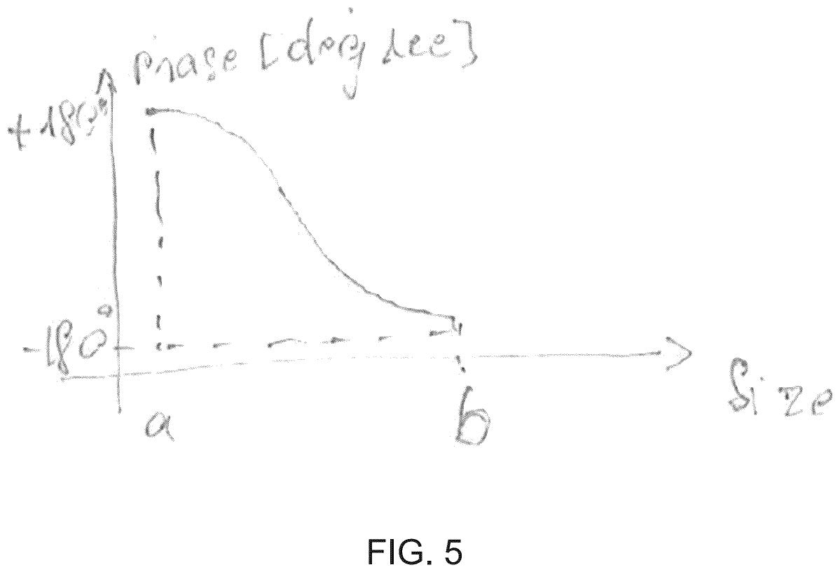

Referring now to FIG. 4, an exemplary reflector 18 or reflect array is illustrated. The reflector 18 may include a number of reflecting portions or elements 20 (i.e., an array of reflecting elements or portions). The portions or elements may be different sizes to generate different reflection phases or phase shifts (i.e., to compensate for different phases from the radar sensor 14 in transmission to the reflector 18), allowing groups or combinations of elements to direct or guide beams from the radar sensor 14 toward regions of interest (FIG. 5). Different sections or regions or portions may direct the beams to different regions of interest. Here, three regions or portions 22A-22C direct three beams to three different regions (e.g., a first row of seats, a second row of seats, and a third row of seats). However, the reflector(s) 18 may include any number of regions to direct the beams at any number of regions of interest (e.g., a separate region for each individual seat of the vehicle). Optionally, each reflector 18 only directs beams to a single region of interest, and instead the system includes multiple reflectors (i.e., one for each region of interest).

The reflector 18 may be passive or active. When passive, the reflector 18 may have a fixed design while, when active, the reflector 18 may manipulate the elements (e.g., a size or position or orientation) to manipulate the phase of the element/region and to control the direction of the reflected beam. The elements 20 of each portion of the reflector 18 causes the beam in that portion to be in phase (FIG. 5), thus directing the beam in a specific direction. The reflector 18 may include components on a flexible substrate. In other examples, the reflector 18 may be installed or mounted directly on a glass roof of the vehicle (i.e., a sunroof or a moonroof) or a window of the vehicle using lamination or etching processes (e.g., on the coated silver layer of the roof).

The radar-reflector or reflect array may comprise any suitable radar-reflective material or elements. For example, the radar-reflector may comprise a radar reflecting element or tape or material, such as a reflector utilizing aspects of the systems described in U.S. Pat. No. 11, 112,498, which is hereby incorporated herein by reference in its entirety. The reflect array may comprise a retroreflective element or elements and/or may have separate and distinct elements or sub-arrays that reflect the radar signals to and from particular respective regions within the cabin of the vehicle so that the radar system can monitor the respective regions for occupant detection.

Thus, the driver or occupant monitoring system or sensing system monitors the interior cabin of the vehicle for presence of humans, animals, and other occupants within a vehicle. For example, the system monitors health signs or any other status to increase the safety of the vehicle (e.g., for children and other high-risk individuals). The system may, for example, detect presence of children left in an unattended vehicle, heart rates of occupants, and/or breathing rates of occupants. The system may detect occupants in conjunction with a seat belt warning system. The system may generate a visual or audible alert (inside the vehicle or outside the vehicle, such as via flashing lights and honking the horn) in response to detecting a health or safety concern or other status condition of one of the occupants of the vehicle. The alert may include a wireless communication to, for example, the owner of the vehicle and/or emergency services. For example, the system may determine that an occupant has remained in the vehicle after the driver has left the vehicle and the system may generate a warning or notification. The system may only generate the warning when certain conditions are met, such as when the occupant is smaller than a threshold size (indicating that the occupant is a child or an animal), the vehicle is off, when the temperature inside or outside of the vehicle meets a threshold, etc.

The system includes a radar sensor and one or more reflectors disposed within the interior of the vehicle, such as at the dashboard or console or the like. The radar sensor transmits one or more focused or narrow “beams” at the reflector which directs each beam to a different respective region of interest within the vehicle (e.g., each row or each seat of the vehicle). The reflecting portions of the reflector provide a line of sensing to direct the transmitted radio signals or beams toward respective regions within the interior cabin of the vehicle. The focused or narrow beams allow the radar sensor to improve performance by reducing noise and increasing resolution. The reflector allows a single radar sensor to sense each region of interest within the vehicle without blockage from the vehicle's interior (e.g., seats of the vehicle). The system, via processing of sensor data captured by the radar sensor, detects presence of occupants within the interior cabin of the vehicle, such as to detect a passenger or child at a rear seat of the vehicle.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular radar sensing system, the vehicular radar sensing system comprising:
a radar sensor disposed at an interior cabin of a vehicle, wherein the radar sensor senses within the interior cabin of the vehicle;
wherein the radar sensor transmits radio signals and receives radio signals;
wherein radar data is captured based on the received radio signals;
an electronic control unit (ECU) comprising electronic circuitry and associated software;
wherein captured radar data is provided to the ECU;
wherein the electronic circuitry of the ECU comprises at least one data processor;
wherein the ECU is operable to process captured radar data provided to the ECU;
a reflector disposed at the interior cabin of the vehicle, wherein the reflector comprises a plurality of radar-reflective portions;
wherein each radar-reflective portion of the plurality of radar-reflective portions of the reflector reflects radio signals transmitted by the radar sensor toward a respective region of interest of a plurality of regions of interest within the interior cabin of the vehicle;
wherein the received radio signals include radio signals that reflect off the plurality of radar-reflective portions of the reflector toward the radar sensor; and
wherein the vehicular radar sensing system, via processing at the ECU of captured radar data, determines presence of an occupant of the vehicle at a region of interest of the plurality of regions of interest within the interior cabin of the vehicle.

2. The vehicular radar sensing system of claim 1, wherein the radar sensor is disposed at a dashboard of the vehicle.

3. The vehicular radar sensing system of claim 1, wherein the reflector is disposed at a headliner of the vehicle.

4. The vehicular radar sensing system of claim 1, wherein each radar-reflective portion of the plurality of radar-reflective portions of the reflector comprises a respective plurality of radar-reflective elements.

5. The vehicular radar sensing system of claim 4, wherein at least one radar-reflective element of the plurality of radar-reflective elements of a respective radar-reflective portion is a different size than at least one other radar-reflective element of the plurality of radar-reflective elements of the respective radar-reflective portion.

6. The vehicular radar sensing system of claim 1, wherein the radar sensor uses beamforming to direct the transmitted radio signals toward the reflector.

7. The vehicular radar sensing system of claim 1, wherein the plurality of regions of interest comprises at least one seat of the vehicle.

8. The vehicular radar sensing system of claim 1, wherein the plurality of regions of interest comprises at least one row of seats of the vehicle.

9. The vehicular radar sensing system of claim 1, wherein the reflector is disposed at a glass portion of the roof of the vehicle.

10. The vehicular radar sensing system of claim 1, wherein the transmitted radio signals from the radar sensor (i) reflect off a first radar-reflective portion of the reflector toward a first region of interest of the plurality of regions of interest within the interior cabin of the vehicle and (ii) reflect off a second radar-reflective portion of the reflector toward a second region of interest of the plurality of regions of interest within the interior cabin of the vehicle, and wherein the received radio signals include radio signals that reflect off the first radar-reflective portion and the second radar-reflective portion toward the radar sensor.

11. The vehicular radar sensing system of claim 10, wherein the first region of interest comprises a seat of a first row of seats within the interior cabin of the vehicle, and wherein the second region of interest comprises a seat of a second row of seats within the interior cabin of the vehicle.

12. The vehicular radar sensing system of claim 10, wherein the first region of interest comprises a seat of a second row of seats within the interior cabin of the vehicle, and wherein the second region of interest comprises a seat of a third row of seats within the interior cabin of the vehicle.

13. The vehicular radar sensing system of claim 1, wherein the reflector comprises a passive reflector.

14. The vehicular radar sensing system of claim 1, wherein the reflector comprises an active reflector, and wherein the active reflector adjusts one or more radar-reflecting elements of a plurality of radar-reflective elements of the reflector to adjust a reflecting direction of the transmitted radio signals incident at the one or more radar-reflective elements.

15. The vehicular radar sensing system of claim 1, wherein the vehicular radar sensing system, responsive to determining the presence of the occupant at a region of interest of the plurality of regions of interest within the interior cabin of the vehicle, determines a health status of the occupant.

16. The vehicular radar sensing system of claim 15, wherein the health status comprises at least one selected from the group consisting of (i) a heart rate of the occupant and (ii) a breathing rate of the occupant.

17. The vehicular radar sensing system of claim 1, wherein the vehicular radar sensing system, responsive to determining the presence of the occupant at a region of interest of the plurality of regions of interest within the interior cabin of the vehicle, transmits a wireless communication to a user device of a user of the vehicle.

18. A vehicular radar sensing system, the vehicular radar sensing system comprising:
a radar sensor disposed at a dashboard of a vehicle, wherein the radar sensor senses within the interior cabin of the vehicle;
wherein the radar sensor transmits radio signals and receives radio signals;
wherein radar data is captured based on the received radio signals;
an electronic control unit (ECU) comprising electronic circuitry and associated software;
wherein captured radar data is provided to the ECU;
wherein the electronic circuitry of the ECU comprises at least one data processor;
wherein the ECU is operable to process captured radar data provided to the ECU;
a reflector disposed at a headliner of the vehicle, wherein the reflector comprises a plurality of radar-reflective portions;
wherein each radar-reflective portion of the plurality of radar-reflective portions of the reflector reflects radio signals transmitted by the radar sensor toward a respective region of interest of a plurality of regions of interest within the interior cabin of the vehicle;
wherein the received radio signals include radio signals that reflect off the plurality of radar-reflective portions of the reflector toward the radar sensor; and
wherein the vehicular radar sensing system, via processing at the ECU of captured radar data, determines presence of an occupant of the vehicle at a region of interest of the plurality of regions of interest within the interior cabin of the vehicle.

19. The vehicular radar sensing system of claim 18, wherein each radar-reflective portion of the plurality of radar-reflective portions of the reflector comprises a respective plurality of radar-reflective elements.

20. The vehicular radar sensing system of claim 19, wherein at least one radar-reflective element of the respective plurality of radar-reflective elements of a respective radar-reflective portion is a different size than at least one other radar-reflective element of the respective plurality of radar-reflective elements of the respective radar-reflective portion.

21. The vehicular radar sensing system of claim 18, wherein the radar sensor uses beamforming to direct the transmitted radio signals toward the reflector.

22. The vehicular radar sensing system of claim 18, wherein the vehicular radar sensing system, responsive to determining the presence of the occupant at a region of interest of the plurality of regions of interest within the interior cabin of the vehicle, determines a health status of the occupant.

23. A vehicular radar sensing system, the vehicular radar sensing system comprising:
a radar sensor disposed at an interior cabin of a vehicle, wherein the radar sensor senses within the interior cabin of the vehicle;
wherein the radar sensor transmits radio signals and receives radio signals;
wherein radar data is captured based on the received radio signals;
an electronic control unit (ECU) comprising electronic circuitry and associated software;
wherein captured radar data is provided to the ECU;
wherein the electronic circuitry of the ECU comprises at least one data processor;
wherein the ECU is operable to process captured radar data provided to the ECU;
a reflector disposed at the interior cabin of the vehicle, wherein the reflector comprises a plurality of radar-reflective portions;
wherein each radar-reflective portion of the plurality of radar-reflective portions of the reflector reflects radio signals transmitted by the radar sensor toward a respective region of interest of a plurality of regions of interest within the interior cabin of the vehicle, and wherein the plurality of regions of interest comprises at least one seat of the vehicle;
wherein the reflector comprises an active reflector, and wherein the active reflector adjusts one or more radar-reflecting elements of a plurality of radar-reflective elements of the reflector to adjust a reflecting direction of the transmitted radio signals incident at the one or more radar-reflective elements;
wherein the received radio signals include radio signals that reflect off the plurality of radar-reflective portions of the reflector toward the radar sensor; and
wherein the vehicular radar sensing system, via processing at the ECU of captured radar data, determines presence of an occupant of the vehicle at a region of interest of the plurality of regions of interest within the interior cabin of the vehicle.

24. The vehicular radar sensing system of claim 23, wherein the reflector is disposed at a glass portion of the roof of the vehicle.

25. The vehicular radar sensing system of claim 23, wherein the radar sensor uses beamforming to direct the transmitted radio signals toward the reflector.

26. The vehicular radar sensing system of claim 23, wherein the transmitted radio signals from the radar sensor (i) reflect off a first radar-reflective portion of the reflector toward a first region of interest of the plurality of regions of interest within the interior cabin of the vehicle and (ii) reflect off a second radar-reflective portion of the reflector toward a second region of interest of the plurality of regions of interest within the interior cabin of the vehicle, and wherein the received radio signals include radio signals that reflect off the first radar-reflective portion and the second radar-reflective portion toward the radar sensor.

27. The vehicular radar sensing system of claim 23, wherein the vehicular radar sensing system, responsive to determining the presence of the occupant at a region of interest of the plurality of regions of interest within the interior cabin of the vehicle, transmits a wireless communication to a user device of a user of the vehicle.
